(19) United States
(12) Patent Application Publication
(10) Pub. No.: US 2016/0272219 A1
(43) Pub. Date: Sep. 22, 2016

(54) SYSTEM AND METHOD FOR CONTROLLING A VEHICLE WITH FAULT MANAGEMENT

(71) Applicant: RENAULT s.a.s., Boulogne Billancourt (FR)

(72) Inventors: Ahmed Ketfi-Cherif, Elancourt (FR); Gregory Launay, Paris (FR); Abdelmalek Maloum, Chevilly Larue (FR); Olivier Scheffges, Clamart (FR); Maxime Debert, Versailles (FR)

(73) Assignee: RENAULT s.a.s., Boulogne Billancourt (FR)

(21) Appl. No.: 15/029,392

(22) PCT Filed: Oct. 2, 2014
(86) PCT No.: PCT/FR2014/052506

§ 371 Date: Apr. 14, 2016

(30) Foreign Application Priority Data
Oct. 17, 2013 (FR) 1360089

(51) Int. Cl. B60W 50/035

(52) U.S. Cl. CPC B60W 50/035

(57) ABSTRACT

A vehicle control system for a motor vehicle includes functional modules for controlling elements of the vehicle, a fault management module generating confirmed fault signals from fault data, and a global management module for the operating modes of the vehicle. The global management module generates a mode signal when it detects at least one confirmed fault signal and distributes, to the functional modules, the mode signal including an instruction to the functional modules to switch the elements of the vehicle to a restricted operating mode in relation to the confirmed fault signal or signals detected.

The invention relates to vehicles, notably motor vehicles, and more specifically the control systems for powertrains and other elements of motor vehicles, in particular for managing malfunctions of the control system and/or of the elements of the vehicle.

Document FR2925408 discloses a system and a method for controlling a vehicle powertrain with breakdown or fault management, using the modularity of the functions controlled. Each functional module independently processes the inputs that it controls in relation to the related breakdowns, thereby facilitating the structural modification of the inputs during subsequent upgrades of the vehicle, considerably reducing development costs.

However, vehicles required to work globally in different operating modes present an additional requirement. One problem is coordinating the reactions of the modules to malfunctions while retaining the benefits of modularity and without overcomplicating exchanges between modules. Another problem is minimizing the need to modify the modules when modifying the inputs and/or operating modes of the vehicle.

The invention is intended to address the problems present in the prior art.

Thus, according to one aspect of the invention, a vehicle control system, notably for a motor vehicle, is proposed, said system comprising functional modules for controlling elements of the vehicle and a fault management module generating confirmed fault signals from fault data. The control system is noteworthy in that it includes a global management module for the operating modes of the vehicle, designed to generate a mode signal when it detects at least one confirmed fault signal and to distribute, to the functional modules, said mode signal comprising an instruction to the functional modules to switch the elements of the vehicle to a restricted operating mode in relation to said confirmed fault signal or signals detected.

In particular, the vehicle control system includes a module for processing inputs designed to generate quantifying and/or logical data intended for the functional modules and fault data intended for the fault management module.

In particular, furthermore, at least one functional module of the vehicle control system is designed to generate quantifying and/or logical data intended for other functional modules and fault data intended for the fault management module.

Advantageously, at least two functional modules each include a management submodule dedicated to restricted modes designed to respond to said instruction in the mode signal in order to control the elements of the vehicle controlled by the functional module accordingly.

In the vehicle control system, the management submodule dedicated to restricted modes may include at least two components for controlling the elements of the vehicle controlled by the functional module that includes the management submodule dedicated to restricted modes and the management submodule dedicated to restricted modes may include a selector for activating one of the components as a function of the mode signal.

In one embodiment of the vehicle control system, a control component is designed to control said elements in either thermal-only operating mode or in electric-only operating mode of the vehicle.

According to another aspect of the invention, a vehicle control method, notably for a motor vehicle, is proposed, said method comprising the following steps of generating confirmed fault signals from fault data relating to the elements of the vehicle controlled by functions, and generating and distributing a mode signal containing an instruction to switch the elements of the vehicle to a restricted operating mode relating to said confirmed fault signal or signals detected such that several functions share the same restricted operating mode of the vehicle.

Specifically, the vehicle control method includes the steps of selecting the restricted operating mode as a function of at least one element state of the vehicle.

According to another aspect of the invention, a computer program is proposed, including program code instructions to perform the steps of the method when said program is run on one or more computers.

Other advantages and features of the invention are set out in the detailed description of the embodiments, which are in no way limiting, in which:

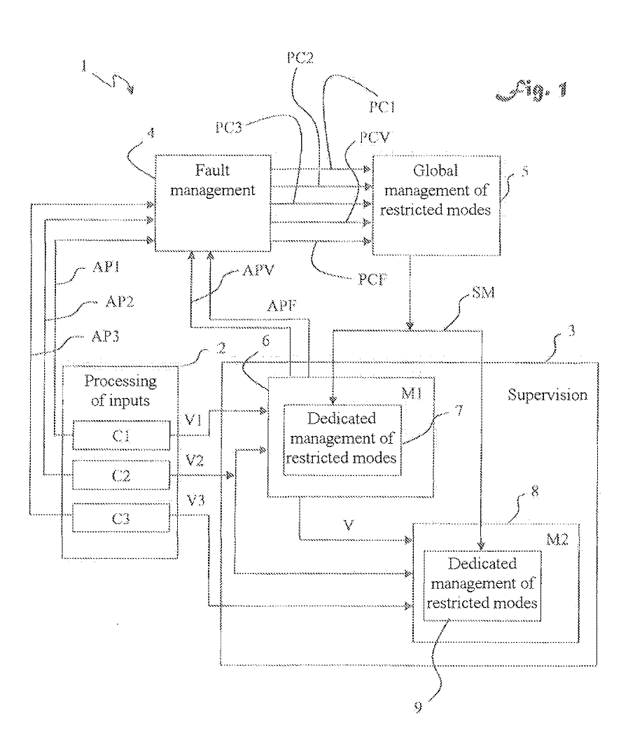

FIG. 1 is a schematic diagram of an embodiment of the invention,

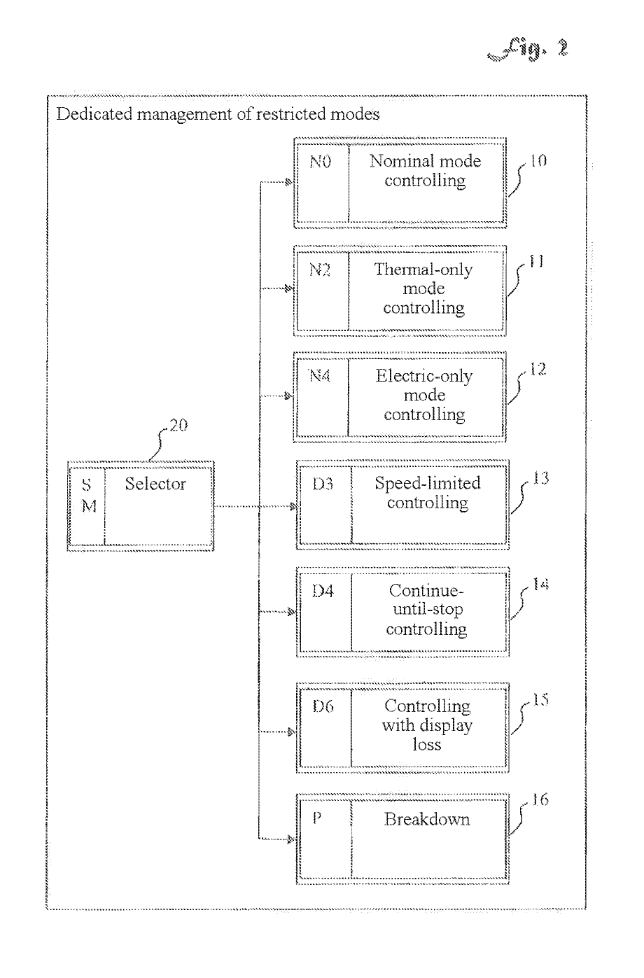

FIG. 2 is a schematic diagram of a detail of an embodiment of the invention,

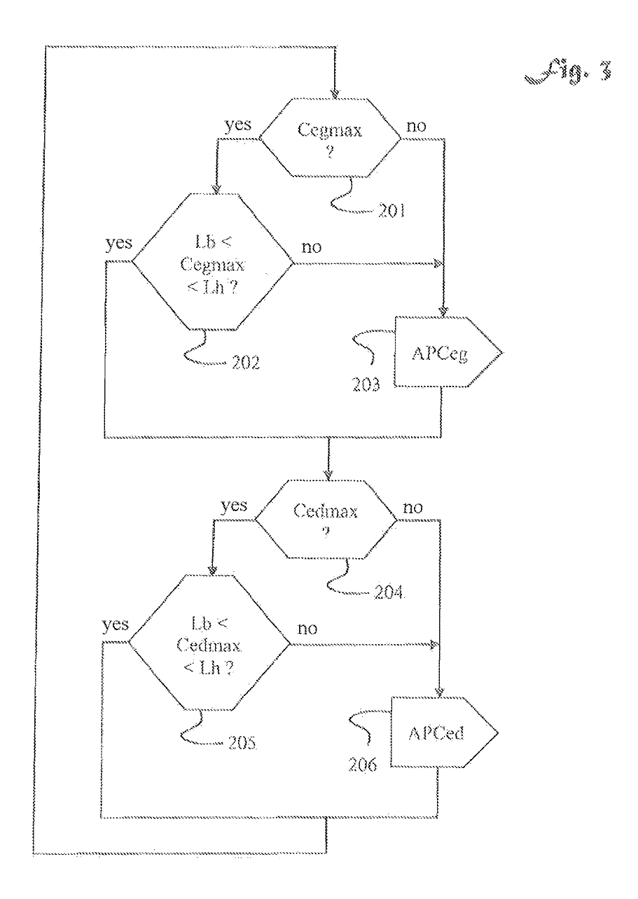

FIGS. 3 to 6 show the possible method steps according to the invention.

In FIG. 1, reference sign 1 indicates a motor vehicle control system that could, purely by way of non-limiting illustrative example, include a petrol or diesel thermal engine, one or more electric motors, thermal-electric hybrid drive, manual, autonomous, remote or any other type of control with several operating modes. The control system has a modular architecture inasmuch as it has different modules, such as software modules, built into one or more control processors, such as a fault management module 4, and different functional modules 6, 8 each configured to control and command, within the system, a function M1, M2 of an element or group of elements in the vehicle. FIG. 1 only shows two functional modules, but it can be easily understood that the number of functional modules may be greater than two in a motor vehicle, and is usually several dozen.

The control system 1 also includes an input processing module 2 including the inputs C1, C2, C3, which are each attributed to an analog or digital signal received by wire or data bus from sensors, control interfaces or other systems, for example telecommunication systems. The module 2 is designed to use the inputs to deliver quantifying and/or logic data V1, V2, V3 to the different functional modules 6, 8. For example, a datum from an input linked to a sensor is typically a detection or measurement value, while a datum from an input linked to a control interface is typically a digital set point value or a binary control value. For example, even a datum from an input connected to a telecommunication system could be a sequence of instructions or settings for actuators.

For example, for an operation M1 related to fuel injection in a thermal engine, the elements include the injectors and the fuel feed pump or pumps. The data V1, V2 received by way of example by the module 6 relate respectively, for example, to the rotational speed of the thermal engine and the travel of the accelerator pedal. Using the data received, which includes V1 and V2, the module 6 prepares the signals to control, for example, the flow rate of the fuel supplied by the injectors and one of the feed pumps. The module 6 can then prepare one or more data V intended for other modules in a supervision unit 3 that groups together the functional modules 6, 8.

For example, for an operation M2 related to the current regulation of an electric machine, the elements include the power electronics connected to the traction battery and/or the service battery. The data V2, V3 received by way of example by the module 8 relate respectively, for example, to the travel of the accelerator pedal and the return current flowing through the electric machine.

The module 8 can also, for example, receive the datum V prepared by the module 6 to communicate a torque value generated by the thermal engine. Using the data received, which include V. V2 and V3, the module 8 prepares signals to control, for example, the current drawn by the power electronics in order to supply a torque to one or more wheels of the vehicle in addition to the torque supplied by the thermal engine or to recharge the battery or batteries of the vehicle. The module 8 can also prepare other data, not shown in the figure, that is intended for the module 6 or other modules within the supervision unit 3.

The processing module 2 for the inputs C1, C2, C3 is designed in a manner known per se to detect potential failures or more generally faults in the acquisition of signals related to same. A fault is for example detected in the event of out-of-scale receipt of an analog voltage signal, absence of an analog current signal or an inconsistent parity check of a digital signal. With regard to the inputs C1, C2, C3, the processing module is designed to deliver the failure or fault data AP1, AP2, AP3 to the fault management module 4.

The inputs of the system in a vehicle are encoded rapidly in tens or in hundreds and the purpose of the description is not in this case to show all of the inputs, but to describe the architecture and how the inputs are processed.

The module 2 may include a computer program containing program code instructions for performing the method steps shown purely by way of non-exhaustive example with reference to FIG. 3, when the program is run on a real-time processing computer linked to the module 2.

Considering for example a controller of two electric machines (not shown) each dedicated respectively to a left-hand wheel and a right-hand wheel of the vehicle, when the controller (not shown) regularly sends a signal Cegmax, Cedmax to the supervisor 3 giving details of the maximum torque applicable to the left-hand electric machine and the right-hand electric machine respectively, non-receipt of one of the signals in step 201, 204, or non-receipt of a valid maximum left-hand or right-hand torque value in step 202, 205, activates a step 203, 206 that involves generating a fault datum, respectively APCeg, APCed, of the data type AP1, AP2, AP3, regardless of the driving mode, i.e. thermal or electric.

Comparably, the functional modules 6, 8 may be designed to detect potential failures or more generally faults in prepared data that are intended for other modules or functional faults. A fault relating to a function F is for example detected in the event of inconsistency between data coming from the input processing module 2 or other functional modules, compared to a behavioral model previously established. A fault relating to a prepared datum V that is intended for one or more other modules and that is for example detected when the data received at the input of the functional module result in an erroneous or contextually doubtful datum. With regard to the functions F handled and the data V prepared by a functional module, the functional module is designed to deliver failure or fault data APV, APF to the fault management module 4.

Using the failure or fault data AP1, AP2, AP3, APV, APF, the fault management module 4 generates confirmed fault signals PC1, PC2, PC3, PCV, PCF, for example Boolean signals, intended for a global restricted-mode management module 5. A fault is deemed to be confirmed if it occurs, for example, from a repetition of failure or fault indicators issued by the input processing module 2 to the fault management module 4.

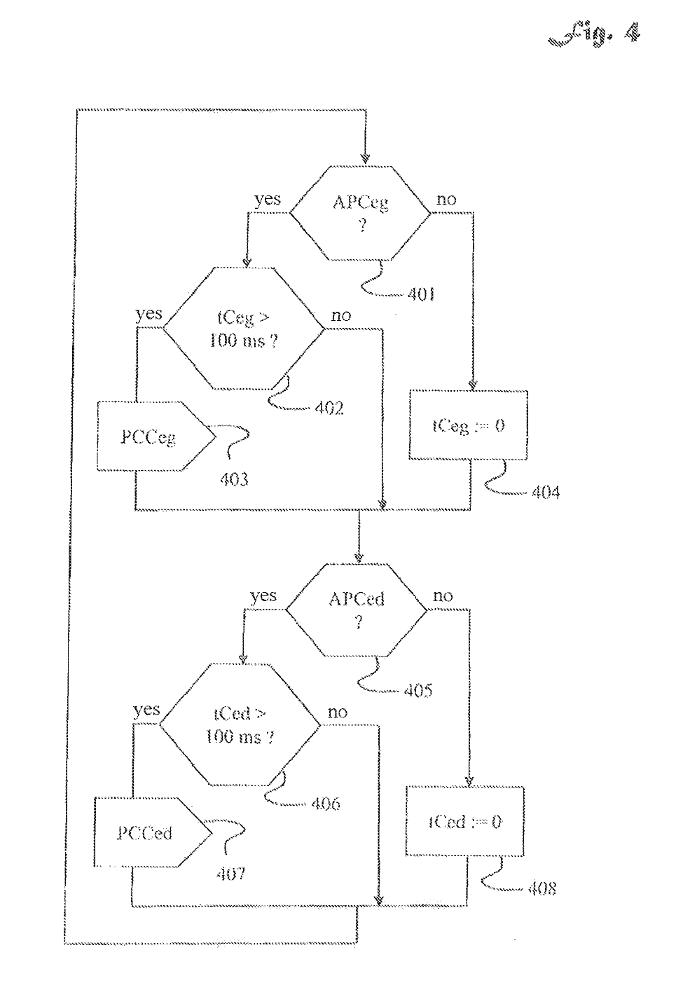

The module 4 may include a computer program containing program code instructions for performing the method steps shown purely by way of non-exhaustive example with reference to FIG. 4, when the program is run on a real-time processing computer linked to the module 4.

With reference for example to the aforementioned controller of two electric machines, illustrated in FIG. 4, the fault management module activates a step 402, 406 when it receives the fault datum APCeg, APCed in step 401, 405 to confirm the fault in the maximum torque datum if the loss is greater than 100 ms. The confirmation times for these faults and other system faults are provided in a summary table stored in a memory. The time check is performed for example in a known manner by incrementing a counter in step 402, 406, reset in step 404, 408 in the event of disappearance of the fault datum in step 401, 405. In relation to said fault, a row in the table may contain values other than values simply relating to a duration, such as a number of fault occurrences by unit of time. The steps of the method are adapted accordingly. Once the fault has been confirmed, the fault management module warns the global restricted-mode management module 5 in step 403, 407, which essentially involves generating the confirmed fault signals PCCeg, PCCed of the type PC1, PC2, PC3, PCV, PCF from fault data APCeg, APCed of the type AP1, AP2, AP3, APV, APF relating to the electric machines from the various elements of the vehicle controlled by functions.

From the confirmed fault signals PC1, PC2, PC3, PCV, PCF, the global restricted-mode management module 5, as shown in FIG. 1, generates a mode signal SM if it detects at least one confirmed fault signal PC1, PC2, PC3, PCV, PCF, updating same if required following the occurrence of new confirmed faults. The global restricted-mode management module 5 distributes the mode signal SM to the functional modules 6, 8. The mode signal SM comprises an instruction shared by all of the functional modules 6, 8 to switch the elements of the vehicle to a common restricted operating mode relating to said confirmed fault signal or signals detected, as explained in the remainder of the description.

The module 5 stores in memory a list of predefined operating modes including a nominal mode associated with an absence of restrictions and restricted modes with degraded operation in relation to the nominal mode.

In a purely non-limiting example of a thermal/electric hybrid drive vehicle, the nominal mode, corresponding for example to an instruction N0, enables both traction by thermal engine and traction by electric machine. The circumstances “fuel tank empty”, “battery discharged” or “speed greater than a tolerance threshold of the electric machine” are not faults but simply operating conditions that do not adversely affect the nominal mode.

A thermal-only mode corresponding, for example, to an instruction N2, is restricted inasmuch as it does not permit traction by electric machine. In this mode, traction by thermal engine generates no fault and the electric machine or machines are disconnected from the wheels. The related faults include electric machine out of order, communication lost or battery out of order.

An electric-only mode corresponding, for example, to an instruction N4, is restricted inasmuch as it does not permit traction by thermal engine. In this mode, traction by electric machine generates no fault and the thermal engine is disconnected from the wheels by putting the gearbox into neutral. The related faults include thermal engine out of order or communication lost.

A speed-limited mode corresponding, for example, to an instruction D3, is restricted inasmuch as it does not enable the vehicle to exceed a speed threshold set by mechanical constraints, such as rotational strength of a rotor of an electric machine. In this mode, locomotion by thermal engine and/or electric machines is possible, but with the loss of fail-safe mode due to the loss of the option of disconnecting the electric machine from one wheel.

A continue-until-stop mode corresponding, for example, to an instruction D4, is restricted inasmuch as it only enables the vehicle to be driven until the driver chooses to stop. The related faults include engaged gear stuck in robotized gearbox or gearbox control stick out of order.

A display-lost mode corresponding, for example, to an instruction D6, is restricted by a specific display loss.

A breakdown mode corresponding, for example, to an instruction P, is restricted by total immobilization of the vehicle.

A set of rules for example makes it possible to activate the relevant operating mode indicated in the action of the rule, the premise containing a combinatorial equation of confirmed faults and, if necessary, other information on the state of different elements of the vehicle.

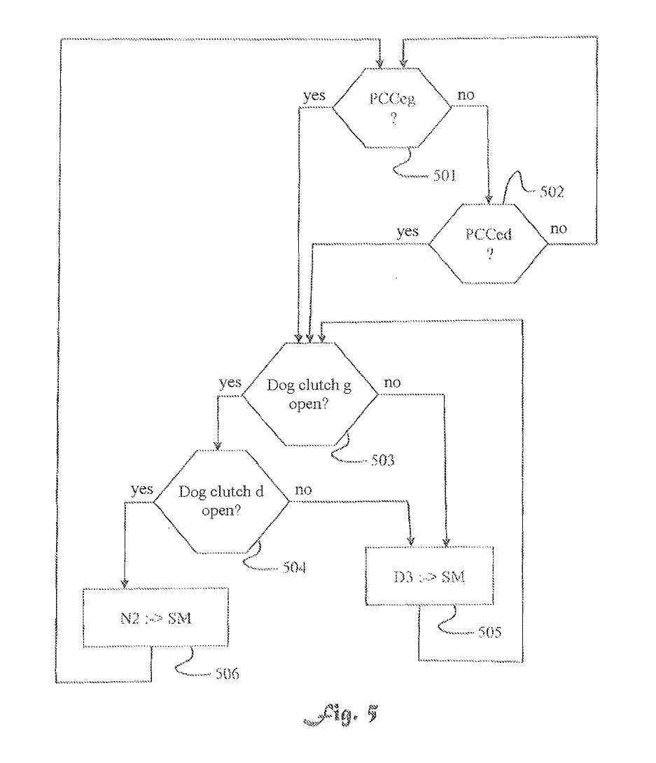

The module 5 may also include a computer program containing program code instructions for performing the method steps shown purely by way of non-exhaustive example with reference to FIG. 5, when the program is run on a real-time processing computer linked to the module 5.

Again with reference for example to the aforementioned controller of two electric machines, illustrated in FIG. 3, the management module 5 activates a step 503, 504 when it receives the confirmed fault signal PCCeg, PCCed in step 501, 502 to select the appropriate mode.

Thus, a step 506 involves loading the instruction N2 into the signal SM to trigger the thermal-only mode, only if the dog clutch is confirmed definitely open in step 503, 504. Otherwise, a step 505 involves loading the instruction D3 into the signal SM to trigger the limited speed mode.

Each functional module 6, 8 also has a dedicated management submodule 7, 9 for restricted operating modes of the element or elements of the vehicle that are controlled or commanded by the module 6, 8.

FIG. 2 shows a possible embodiment of dedicated restricted-mode management submodule according to the invention.

The submodule shown here may provide a restricted-mode management for the operation M1, M2 of the element or elements that are controlled or commanded by the functional module to which the submodule belongs.

The submodule includes at least two components, each being associated with an operating mode of the vehicle.

A component 10 is designed to control the operation M1, M2 of the element or elements that corresponds to a nominal operating mode of the vehicle. The nominal operating mode of the vehicle is not restricted inasmuch as, in the absence of any fault, it enables all of the functionalities provided in the vehicle to be used as desired by the user and in response to the environmental context elements of the vehicle. For example, a fuel level in the tank is not a fault, but an environmental context element in the same way as a road condition that is suitable or unsuitable for motor vehicles.

For example, the nominal operating mode of a hybrid vehicle permits the thermal operating mode, the electric operating mode and the combination of thermal and electric modes of same under the conditions initially provided in the specifications of the vehicle.

Again for example, the nominal operating mode of a vehicle with mixed autonomous-manual driving permits the manual operating mode, the autonomous operating mode and switching between driving modes of same under the conditions initially provided in the specifications of the vehicle.

A naming convention preferably shared by at least the global restricted-mode management module 5 and by the dedicated restricted-mode management submodules 7, 9 enables the component 10 to be addressed using an index N0.

Like the control component 10, control components 11, 12, 13, 14, 15, 16 are dedicated specifically to the elements of the vehicle that are controlled and commanded by the functional module to which the dedicated restricted-mode management submodule belongs.

The shared naming convention makes it possible to address each of the components 11, 12, 13,14, 15, 16 using respectively an index N1, N4, D3, D6, P.

The component 11 is designed to control the operation M1, M2 of the element or elements that corresponds to a thermal-only operating mode of the vehicle. The thermal-only operating mode of the vehicle is restricted inasmuch as an existence of a fault enables only the functionalities provided in the vehicle for purely thermal traction to be used.

For example, the thermal-only operating mode of a hybrid vehicle does not permit the electric operating mode of same or the combination of electric and thermal modes.

Thus, using the example given above of the functional module 6 that controls and commands the operation M1 related to fuel injection in the thermal engine, under normal circumstances in which the elements including injectors and the fuel feed pump or pumps can be controlled identically in nominal mode and in thermal-only operating mode of the vehicle, the component 11 can be the same as the component 10.

In the example given above of the functional module 8 that controls and commands the operation M2 related to the current regulation of an electric machine, for the elements making up the power electronics connected to the traction battery and/or the service battery that are not required to work in thermal-only operating mode of the vehicle, the component 11 can be limited to controlling the disconnection of the power electronics and, if necessary, the disconnection of the electric machine from the drive wheel or wheels.

The component 12 is designed to control the operation M1, M2 of the element or elements that corresponds to an electric-only operating mode of the vehicle. The electric-only operating mode of the vehicle is restricted inasmuch as an existence of a fault only enables the functionalities provided in the vehicle for purely electric traction to be used.

For example, the electric-only operating mode of a hybrid vehicle does not permit the thermal operating mode of same or the combination of electric and thermal modes.

Thus, with reference to the example given above of the functional module 6 that controls and commands the operation M1 related to fuel injection in the thermal engine, for the injectors and the fuel feed pump or pumps that are not required to work in electric-only mode, the component 12 can be limited to controlling the disconnection of same and, if necessary, the disconnection of the engine from the drive wheel wheels.

In the example given above of the functional module 8 that controls and commands the operation M2 related to the current regulation of the electric machine, the elements comprising the power electronics connected to the traction battery and/or to the service battery may operate in electric-only operating mode of the vehicle, in a manner comparable to the nominal mode. In the functional module 8, the component 12 can then be the same as the component 10.

The component 13 is designed to control the operation M1, M2 of the element or elements that corresponds to a speed-limited operating mode of the vehicle. The speed-limited operating mode of the vehicle beneath a threshold is restricted inasmuch as an existence of a fault prevents the functionalities provided in the vehicle for traction at a speed above the threshold to be used.

Thus, with reference again to the example given above of the functional module 6 that controls and commands the operation M1 related to fuel injection in the thermal engine, and respectively of the functional module 8 that controls and commands the operation M2 related to the current regulation of an electric machine, the elements comprising the injectors and the fuel feed pump or pumps, and respectively the elements comprising the power electronics connected to the traction battery and/or the service battery, can be controlled in a restricted manner in relation to the nominal mode and to the thermal-only mode, and respectively to the electric-only operating mode of the vehicle. The component 13 may include set point limitations applied to one of the components 10, 11, and respectively to one of the components 10, 12.

The component 14 is designed to control the operation M1, M2 of the element or elements that corresponds to a continue-until-stop operating mode of the vehicle. The continue-until-stop operating mode of the vehicle is restricted inasmuch as an existence of a fault requires the vehicle to be stopped as quickly as possible under optimum conditions.

Thus, with reference again to the example given above of the functional module 6 that controls and commands the operation M1 related to fuel injection in the thermal engine, and respectively of the functional module 8 that controls and commands the operation M2 related to the current regulation of an electric machine, the elements comprising the injectors and the fuel feed pump or pumps, and respectively the elements comprising the power electronics connected to the traction battery and/or the service battery, can be gradually reduced to zero in relation to the nominal mode and to the thermal-only mode, and respectively to the electric-only operating mode of the vehicle. The component 14 may include decreasing set points applied to one of the components 10, 11, and respectively to one of the components 10, 12.

The component 15 is designed to control the operation M1, M2 of the element or elements that corresponds to a display-loss operating mode of the vehicle. The display-loss operating mode of the vehicle with is restricted inasmuch as an existence of a fault prevents vehicle data from being obtained from the displays.

The component 16 is designed to control the operation M1, M2 of the element or elements that corresponds to a operating mode of a broken-down vehicle. The operating mode of a broken-down vehicle is restricted inasmuch as the existence of a fault prevents the vehicle from working.

The control components described above are non-mandatory examples. They may be replaced or combined with other control components as a function of vehicle type.

For example, in a vehicle with no electric drive machine, the control component 12 and either one of the components 10, 11 may be omitted, the nominal mode corresponding to the thermal-only mode.

Furthermore, in a vehicle with no thermal drive engine, the control component 11 and either one of the components 10, 12 may be omitted, the nominal mode corresponding to the electric-only mode.

In a dual-mode manual/autonomous vehicle, there may be a control component for forced operation in autonomous mode and a control component for forced operation in manual mode of the elements controlled by the functional modules 6, 8. The nominal-mode control component 10 is then provided to enable operation in either autonomous mode or in manual mode as required by the user or the PLCs in higher application levels, with no imposed fault restrictions.

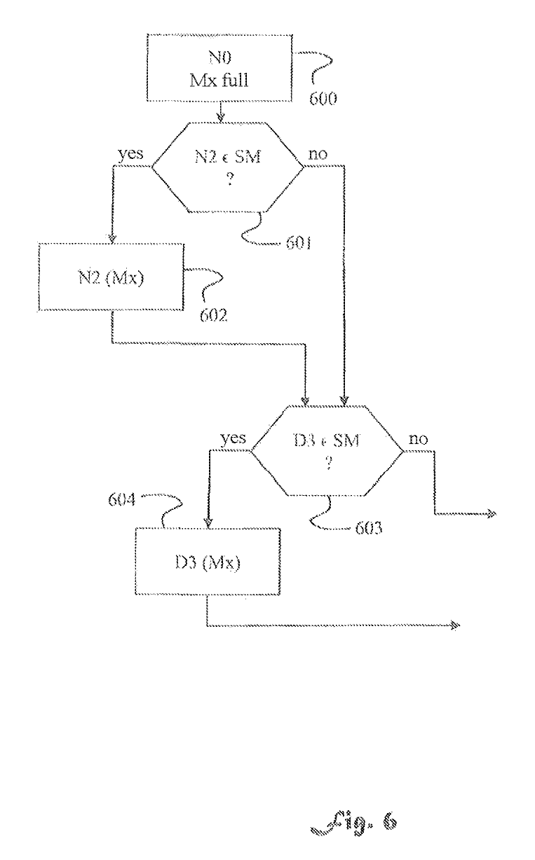

Each module 6, 8 may include a computer program containing program code instructions for performing the method steps shown purely by way of non-exhaustive example with reference to FIG. 6, when the program is run on a real-time processing computer linked to the module 6, 8.

With reference again for example to the controller of two electric machines, as shown in FIGS. 3 to 5, each basic function M1, M2 of the supervisor 3 performs the actions required to switch to the mode referred to as N2 or D3. That is to say for example, from a mode activated in the preceding step 600, if the mode D3 is activated in step 603, and the torque is distributed 100% to the thermal engine in step 602 by activation of mode N2 in step 601, a speed limiter then prevents, in step 604, the vehicle from exceeding 90 km/h in order to protect the electric machines.

The method then includes other steps (not shown) to activate (or otherwise) other modes as a function of the instructions contained in the signal SM.

1-10. (canceled)

11. A vehicle control system for a motor vehicle, comprising:
functional modules for controlling elements of the vehicle;
a fault management module generating confirmed fault signals from fault data; and
a global management module for the operating modes of the vehicle, the global management module being configured to generate a mode signal when it detects at least one confirmed fault signal and to distribute, to the functional modules, said mode signal comprising an instruction to the functional modules to switch the elements of the vehicle to a restricted operating mode in relation to said confirmed fault signal or signals detected.

12. The vehicle control system as claimed in claim 11, further comprising:
a module for processing inputs designed to generate quantifying and/or logical data for the functional modules and fault data for the fault management module.

13. The vehicle control system as claimed in claim 11, wherein at least one of the functional modules is designed to generate quantifying and/or logical data for other functional modules and fault data for the fault management module.

14. The vehicle control system as claimed in claim 11, wherein at least two of the functional modules each include a management submodule dedicated to restricted modes to respond to said instruction in the mode signal in order to control the elements of the vehicle controlled by the functional module accordingly.

15. The vehicle control system as claimed in claim 14, wherein the management submodule dedicated to restricted modes includes at least two components for controlling the elements of the vehicle controlled by the functional module that includes the management submodule dedicated to restricted modes, and the management submodule dedicated to restricted modes includes a selector for activating one of the components as a function of the mode signal.

16. The vehicle control system as claimed in claim 11, further comprising:
a control component to control said elements in a thermal-only operating mode of the vehicle.

17. The vehicle control system as claimed in claim 11, further comprising:
a control component to control said elements in an electric-only operating mode of the vehicle.

18. A vehicle control method for a motor vehicle, comprising:
generating confirmed fault signals from fault data relating to elements of the vehicle controlled by functions; and
generating and distributing a mode signal containing an instruction to switch the elements of the vehicle to a restricted operating mode relating to said confirmed fault signal or signals detected such that several functions share the same restricted operating mode of the vehicle.

19. The vehicle control method as claimed in claim 18, further comprising:
selecting the restricted operating mode as a function of at least one element state of the vehicle.

20. A non-transitory computer readable medium storing program code instructions that, when executed by a computer, cause the computer to execute the method according to claim 18.
